(19) United States
(12) Patent Application Publication
(10) Pub. No.: US 2014/0068495 A1
(43) Pub. Date: Mar. 6, 2014

(54) APPARATUS AND METHOD FOR PROCESSING HANDWRITING INPUT

(71) Applicants: XIANG HE, Shenzhen City (CN); CHIH-SAN CHIANG, Tu-Cheng (TW); TE-JIA LIU, Shenzhen City (CN); HAI-SEN LIANG, Shenzhen City (CN); HUA-DONG CHENG, Shenzhen City (CN); HAI-JUN MAO, Shenzhen City (CN); XIAO-GUANG LI, Shenzhen City (CN)

(72) Inventors: XIANG HE, Shenzhen City (CN); CHIH-SAN CHIANG, Tu-Cheng (TW); TE-JIA LIU, Shenzhen City (CN); HAI-SEN LIANG, Shenzhen City (CN); HUA-DONG CHENG, Shenzhen City (CN); HAI-JUN MAO, Shenzhen City (CN); XIAO-GUANG LI, Shenzhen City (CN)

(21) Appl. No.: 13/663,493

(22) Filed: Oct. 30, 2012

(30) Foreign Application Priority Data
Sep. 5, 2012 (CN) 2012103239250

(51) Int. Cl. G06F 3/041; G06F 3/048

(52) U.S. Cl. 715/780; 345/173

(57) ABSTRACT

An apparatus for processing handwriting input includes a touch display unit, a touch display control unit, a storage unit, a calculating unit, and a processing unit. The touch display control unit determines a character in response to a character operation by an input device, and a height and a width of an imaginary rectangle sized to fittingly encircle the character. The calculating unit enlarges the height of the imaginary rectangle by adding a given value to the height of the imaginary rectangle if the height of the imaginary rectangle is smaller than a predetermined value. The processing unit resizes the character displayed within the enlarged imaginary rectangle by a first scaling factor. The touch display control unit controls the touch display unit to display the resized character in one of rows of a character display portion provided by the touch display unit. A related method is also described.

### BACKGROUND

1. Technical Field

The present disclosure relates to handwriting input technology, and particularly to an apparatus and method for processing handwriting input.

2. Description of the Related Art

Touch screens are common in electronic devices, and some touch input devices include a touch panel and an input device, such as stylus, for inputting handwriting on the touch panel. The handwriting input by the input device is commonly stored in an image mode without any embellishment, and the size, the height, or the width of some characters of the input handwriting may be quite different from others, which result in impure format.

### BRIEF DESCRIPTION OF THE DRAWING

The components in the drawings are not necessarily drawn to scale, the emphasis instead being placed upon clearly illustrating the principles of the disclosure. Moreover, in the drawing, like reference numerals designate corresponding parts throughout the several views.

FIG. 1 is a diagram block of an apparatus for processing handwriting input, according to an exemplary embodiment.

FIG. 2 is a using state for illustrating handwriting input on the apparatus of FIG. 1.

FIG. 3 is a flowchart of a method for processing handwriting input, according to an exemplary embodiment.

### DETAILED DESCRIPTION

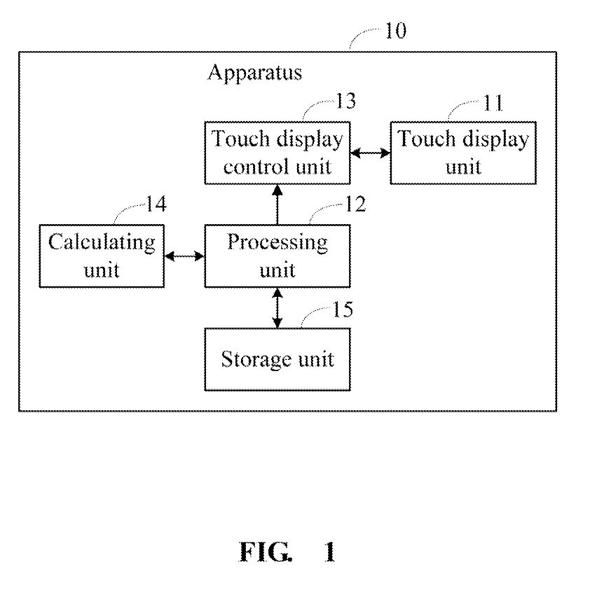

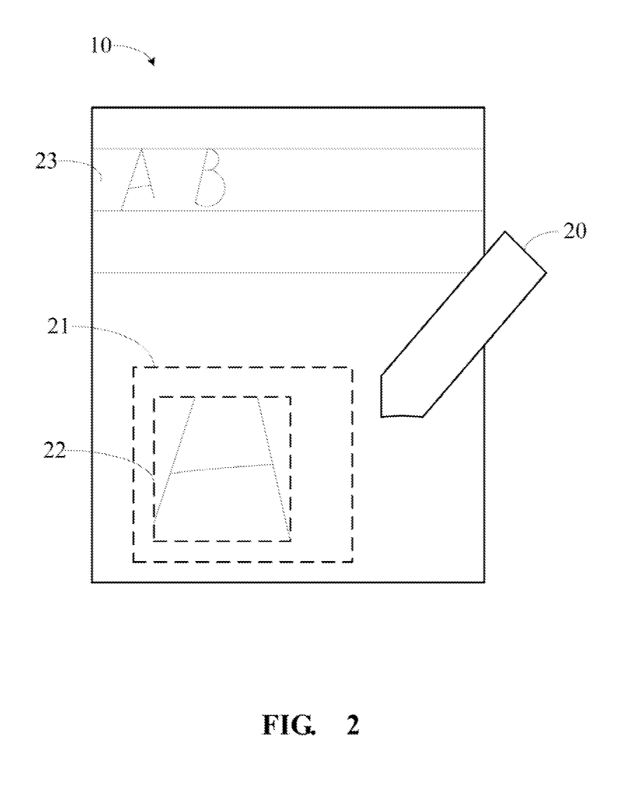

Referring to FIGS. 1 and 2, an apparatus 10 for processing handwriting input is employed and operated by user via an input device 20. The input device 20 may be a stylus, a pen, or the like. The apparatus 10 includes a touch display unit 11, a processing unit 12, a touch display control unit 13, a calculating unit 14, and a storage unit 15.

When the input device 20 touches the touch display unit 11 to input handwriting, the touch display control unit 13 detects a touched position on the touch display unit 11 in response to a character input operation by the input device 20. The processing unit 12 determines an input box 21 according to the touched position, and the touch display control unit 13 controls the touch display unit 11 to display the input box 21. The size of the input box 21 is smaller than that of the touch display unit 11. The touch display unit 11 includes a character displaying portion 23 including a plurality of rows, and each row has a fixed height.

When the touch display unit 11 displays the input box 21, the touch display control unit 13 determines a touch trace of the input device 20 in the input box 21 to determine a character corresponding to the touch trace. The touch display control unit 13 further determines a height and a width of an imaginary undisplayed rectangle sized to fittingly encircle the determined character.

The storage unit 15 further stores a predetermined height value, a fixed height R_{H} of each row, and a predetermined width R_{W} of each character displayed in each row of the character displaying portion 23. The character is resized by a predetermined scaling factor when displayed in the character displaying portion 23, so that the character can be received in one of the plurality of rows.

The calculating unit 14 obtains the height of the imaginary rectangle h, and determines whether the height of the imaginary rectangle h is smaller than the predetermined height value stored in the storage unit 15.

When the height of the imaginary rectangle h is smaller than the predetermined value, the calculating unit 14 further enlarges the height of the imaginary rectangle by adding a given value X to the height of the imaginary rectangle h. The processing unit 13 resizes the character displayed within the enlarged imaginary rectangle by a first scaling factor S. The touch display control unit 13 controls the touch display unit 11 to display the resized character in one of the rows of the character display portion 23. The first scaling factor S is calculated by the following formulas:

A=w/R_{W};

B=(h+X)/R_{H};

If A<=B, S=A, and if A>B, S=B. Namely, the first scaling factor S is equal to the smaller one of w/R_{W} and (h+X)/R_{H}.

When the height of the imaginary rectangle h is not smaller than the predetermined height value, the processing unit 13 further resized the character displayed within the imaginary rectangle by a second scaling factor S′. The touch display control unit 13 controls the touch display unit 11 to display the resized character in one of the rows of the character display portion 23. The second scaling factor S′ is calculated by the following formulas:

A′=w/R_{W};

B′=h/R_{H};

If A′<=B′, S′=A′, and if A′>B′, S′=B′. Namely, the second scaling factor S′ is equal to a smaller one of w/R_{W} and h/R_{H}.

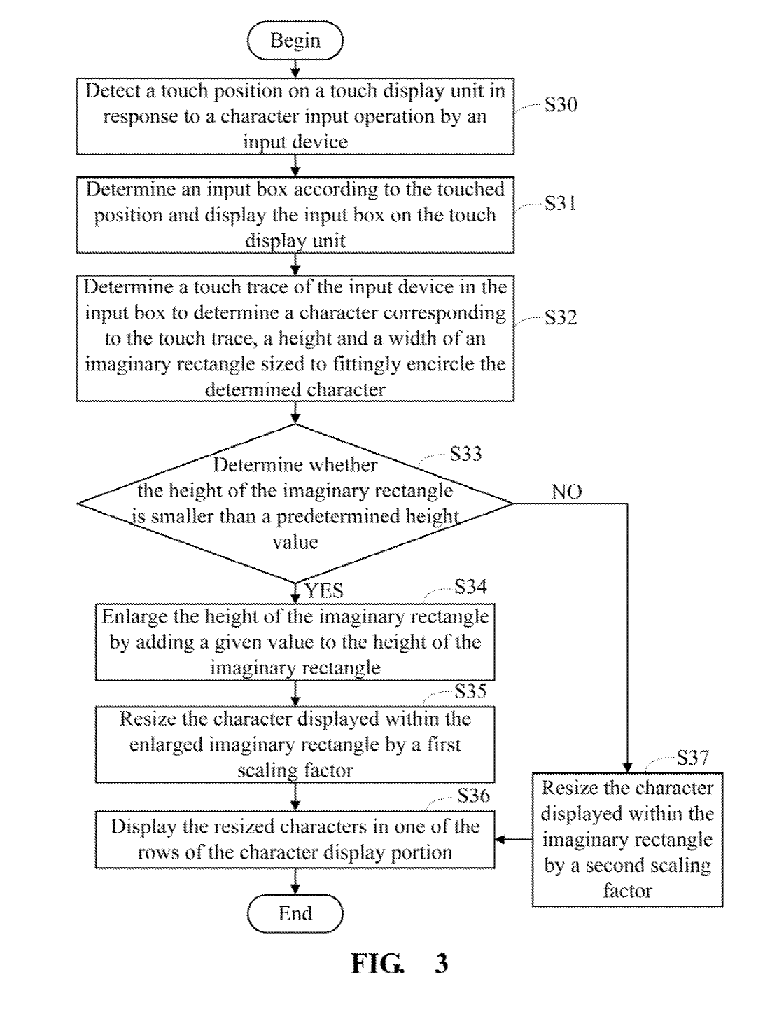

Referring to FIG. 3, a flowchart of a method for processing handwriting input is provided.

In step S30, the touch display control unit 13 detects the touched position on the touch display unit 11 in response to a character input operation by the input device 20.

In step S31, the processing unit 12 determines an input box 21 according to the touched position, and the touch display control unit 13 controls the touch display unit 11 to display the input box 21.

The size of the input box is smaller than that of the touch display unit 11. The touch display unit 11 includes the character displaying portion 23 including a plurality of rows, and each row has a fixed height.

In step S32, the touch display control unit 13 determines a touch trace of the input device 20 in the input box 21 to determine a character corresponding to the touch trace, and further determines the height and the width of the imaginary undisplayed rectangle sized to fittingly encircle the determined character.

In step S33, the calculating unit 14 obtains the height of the imaginary rectangle h, and determines whether the height of the imaginary rectangle h is smaller than the predetermined height value. If yes, the procedure goes to step S34, otherwise, the step goes to step S37.

The storage unit 15 stores the predetermined height value, the fixed height R_{H} of each row, and the predetermined width R_{W} of each character displayed in each row of the character displaying portion 23.

In step S34, the calculating unit 14 further enlarges the height of the imaginary rectangle by adding a given value X to the height of the imaginary rectangle h.

In step S35, the processing unit 13 resizes the character displayed within the enlarged imaginary rectangle by a first scaling factor S.

The first scaling factor S is equal to w/R_{W} and (h+X)/R_{H}, whichever is smaller.

In step S36, the touch display control unit 13 controls the touch display unit 11 to display the resized character in one of the rows of the character display portion 23.

In step S37, the processing unit 15 further resized the character displayed within the imaginary rectangle by a second scaling factor S′. Then the procedure returns back to S36.

The second scaling factor S′ is equal to w/R_{W} and h/R_{H}, whichever is smaller.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An apparatus for processing handwriting input comprising:
a touch display unit comprising a character displaying portion including a plurality of rows, and each row having a fixed height;
a touch display control unit configured for detecting a touched position on the touch display unit in response to a character input operation by an input device; determining a touch trace of the input device to determined a character corresponding to the touch trace, and further determining a height and a width of an imaginary undisplayed rectangle sized to fittingly encircle the determined character;
a storage unit configured for storing a predetermined height value, a fixed height of each row, and a predetermined width of each character displayed in each row of the character displaying portion;
a calculating unit configured for obtaining the height of the imaginary rectangle, and determining whether the height of the imaginary rectangle is smaller than the predetermined height value stored in the storage unit, and enlarging the height of the imaginary rectangle by adding a given value to the height of the imaginary rectangle if the height of the imaginary rectangle is smaller than the predetermined value; and
a processing unit configured for resizing the character displayed within the enlarged imaginary rectangle by a first scaling factor, and the touch display control unit configured to control the touch display unit to display the resized character in one of the rows of the character display portion, wherein the first scaling factor is equal to w/R_{W} or (h+X)/R_{H}, whichever is smaller, wherein w is the width of the imaginary rectangle, h is the height of the imaginary rectangle, R_{W} is a predetermined width of each character displayed in each row of the character displaying portion, R_{H} is the fixed height of each row, x is the given value added to the height of the imaginary rectangle.

2. The apparatus as claimed in claim 1, wherein the processing unit is further configured for controlling the touch display unit to display an input box according to the touched position for allowing the user to input a character therein, and the size of the input box is smaller than that of the touch display unit.

3. The apparatus as claimed in claim 1, wherein the processing unit further configured for resizing the character displayed within the imaginary rectangle by a second scaling factor if the height of the imaginary rectangle is smaller than the predetermined value, and the touch display control unit is configured to control the touch display unit to display the resized character in one of the rows of the character display portion, wherein the second scaling factor is equal to w/R_{W} or h/R_{H}, whichever is smaller, wherein w is the width of the imaginary rectangle, h is the height of the imaginary rectangle, R_{W} is a predetermined width of each character displayed in each row of the character displaying portion, R_{H} is the fixed height of each row.

4. A method for processing handwriting input comprising:
displaying an input box on a touch screen for allowing a user to input a character inside the input box, the size of the input box being smaller than that of the touch screen, the touch screen comprising a character displaying portion including a plurality of rows, each row having a fixed height;
detecting a touch trace of the user in the input box to determine a character corresponding to the touch trace;
determining a height and a width of an imaginary undisplayed rectangle sized to fittingly encircle the determined character;
determining whether the height of the imaginary rectangle is smaller than a predetermined height value;
enlarging the height of the imaginary rectangle by adding a given value to the height of the imaginary rectangle if the height of the imaginary rectangle is smaller than the predetermined height value;
resizing the character displayed within the enlarged imaginary rectangle by a first scaling factor; and
displaying the resized character in one of the rows of the character display portion, wherein the first scaling factor is equal to w/R_{W} or (h+X)/R_{H}, whichever is smaller, wherein w is the width of the imaginary rectangle, h is the height of the imaginary rectangle, R_{W} is a predetermined width of each character displayed in each row of the character displaying portion, R_{H} is the fixed height of each row, X is the given value added to the height of the imaginary rectangle.

5. The method as claimed in claim 4, further comprising:
displaying the input box in response to a character input operation by a user, the input box being displayed at a touched position on the touch screen by the user.

6. A method of processing handwriting input comprising:
displaying an input box on a touch screen for allowing a user to input a character inside the input box, the size of the input box being smaller than that of the touch screen, the touch screen comprising a character displaying portion including a plurality of rows, each row having a fixed height;
detecting a touch trace of the user in the input box to determine a character corresponding to the touch trace;
determining a height and a width of an imaginary undisplayed rectangle sized to fittingly encircle the determined character;
determining whether the height of the imaginary rectangle is smaller than a predetermined height value;
resizing the character displayed within enlarged imaginary rectangle by a second scaling factor if the height of the imaginary rectangle is not smaller than the predetermined height value; and
displaying the resized character in one of the rows of the character display portion, wherein the second scaling factor is equal to w/R_{W} or h/R_{H}, whichever is smaller, wherein w is the width of the imaginary rectangle, h is the height of the imaginary rectangle, R_{W} is a predetermined width of each character displayed in each row of the character displaying portion, R_{H} is the fixed height of each row.
